(19) United States
(12) Patent Application Publication
(10) Pub. No.: US 2010/0321514 A1
(43) Pub. Date: Dec. 23, 2010

(54) METHODS AND SYSTEMS FOR IMAGE CAPTURE AND PROCESSING

(75) Inventor: Wen-Hung Hsieh, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/550,756

(22) Filed: Aug. 31, 2009

(30) Foreign Application Priority Data
Jun. 19, 2009 (TW) 98120581

(51) Int. Cl. H04N 5/228

(52) U.S. Cl. 348/222.1; 348/E05.031

(57) ABSTRACT

Image capture and processing methods and systems are provided. First, an image is captured via an image capture unit. Then, a plurality of smaller images is created according to the image, and the image and the smaller images are stored into an image file. The resolutions of the respective smaller images are the same. Then, the smaller images are obtained from the image file. The smaller images are combined to obtain a specific image, and the specific image is displayed in a display unit.

### CROSS REFERENCE TO RELATED APPLICATIONS

This Application claims priority of Taiwan Patent Application No. 098120581, filed on Jun. 19, 2009, the entirety of which is incorporated by reference herein.

### BACKGROUND OF THE INVENTION

1. Field of the Invention

The disclosure relates generally to methods and systems for image capture and processing, and, more particularly to methods and systems that can create a plurality of smaller images, and/or speed up image browsing using the smaller images.

2. Description of the Related Art

Recently, digital cameras have become a common device, due to the slim size of the cameras, and ease of review and processing of captured images in related devices such as computers.

Image sensors such as charge coupled device (CCD) or complementary metal oxide semiconductor (CMOS) in the digital cameras are used to sense and capture images. After an image is captured, the processing unit of the digital camera processes the image, and displays the image via a display unit of the digital camera, such that users can review the image via the display unit. With the advancement of technology, the resolution of the image sensor has become higher. Since a higher image resolution of an image can be captured via the image sensor, a huge amount of data is required for the captured image after the image is captured. The processing of a large-sized image is time-consuming, and must occupy resources of a processing unit. Consequently, when users want to review the captured image via the display unit of the digital camera, the processing time for generating an image to be displayed in the display unit from an original image of the captured image by the processing unit is increased, such that pauses when switching among images to be reviewed may occur.

### BRIEF SUMMARY OF THE INVENTION

Methods and systems for image capture and processing are provided. In the application, after an image is captured, a plurality of smaller images are created according to the image, and provided for subsequent review of the image. When the image is reviewed, the smaller images are combined to generate an image to be reviewed, thus reducing the processing time for generating the image to be reviewed.

In an embodiment of a method for image capture and processing, an image is captured via an image capture unit. Then, a plurality of smaller images is created according to the image, and the image and the smaller images are stored as an image file, wherein the resolutions of the respective smaller images are the same.

In an embodiment of a method for image capture and processing, a plurality of smaller images is obtained from an image file, wherein the resolutions of the respective smaller images are the same. Then, the smaller images are combined to obtain a specific image, and the specific image is displayed in a display unit.

An embodiment of a system for image capture and processing includes an image capture unit, and a processing unit. The image capture unit captures an image. The processing unit creates a plurality of smaller images according to the image, and stores the image and the smaller images as an image file, wherein the resolutions of the respective smaller images are the same.

An embodiment of a system for image capture and processing includes a storage unit, a display unit, and a processing unit. The storage unit includes an image file. The processing unit obtains a plurality of smaller images from the image file, wherein the resolutions of the respective smaller images are the same. Then, the processing unit combines the smaller images to obtain a specific image, and displays the specific image in the display unit.

Methods and systems for image capture and processing may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for image capture and processing of the invention;

FIG. 2 is a flowchart of an embodiment of a method for image capture and processing of the invention;

FIG. 3 is a schematic diagram illustrating an embodiment of an example of an image of the invention;

FIGS. 4A˜4D are schematic diagrams illustrating an embodiment of examples of smaller images of the invention; and

FIG. 5 is a flowchart of an embodiment of a method for image capture and processing of the invention.

### DETAILED DESCRIPTION OF THE INVENTION

Methods and systems for image capture and processing are provided.

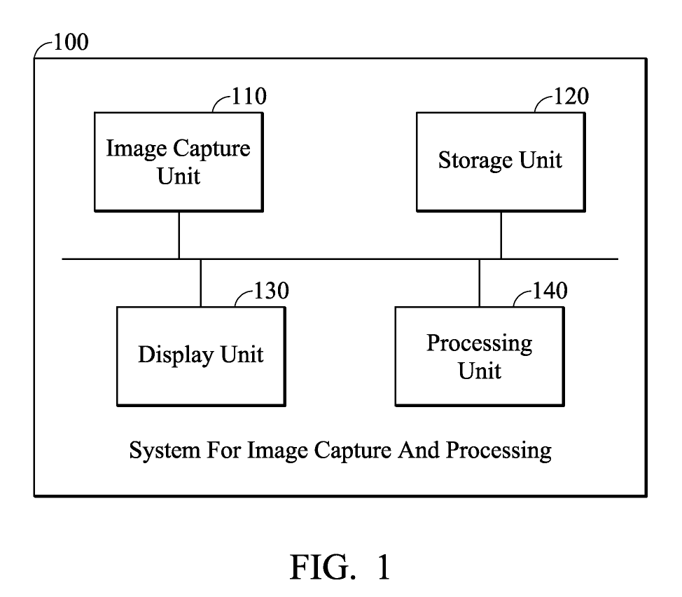

FIG. 1 is a schematic diagram illustrating an embodiment of a system for image capture and processing of the invention. The system for image capture and processing 100 may be an electronic device, such as a digital camera, or a handheld device having an image capture capability, such as a PDA, a smart phone, and a mobile phone.

The system for image capture and processing 100 comprises an image capture unit 110, a storage unit 120, a display unit 130, and a processing unit 140. The image capture unit 110 may be a CCD or a CMOS to capture images. The storage unit 120 can permanently or temporarily store images captured by the image capture unit 110, and/or image files corresponding to the captured images. The display unit 130 can display images, smaller images, such as image thumbnails, and/or related figures and interfaces. The processing unit 140 performs the method for image capture and processing of the invention, which will be discussed further in the following paragraphs.

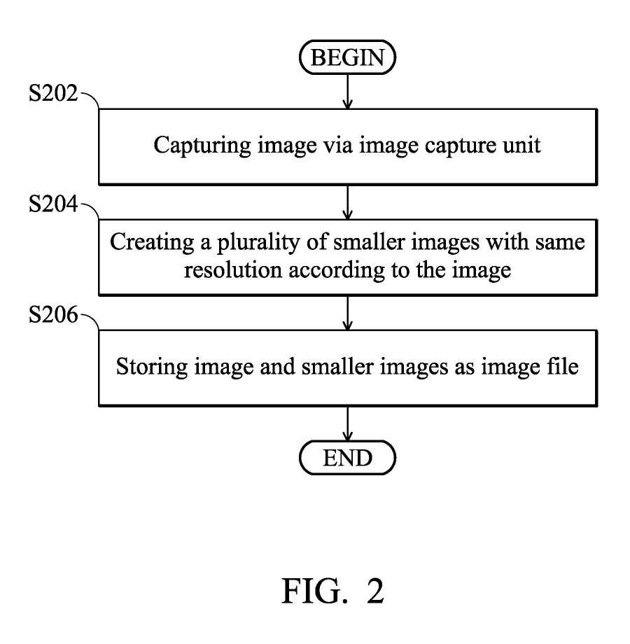

FIG. 2 is a flowchart of an embodiment of a method for image capture and processing of the invention. The method for image capture and processing can be used in an electronic device, such as a digital camera, or a handheld device having an image capture capability, such as a PDA, a smart phone, and a mobile phone.

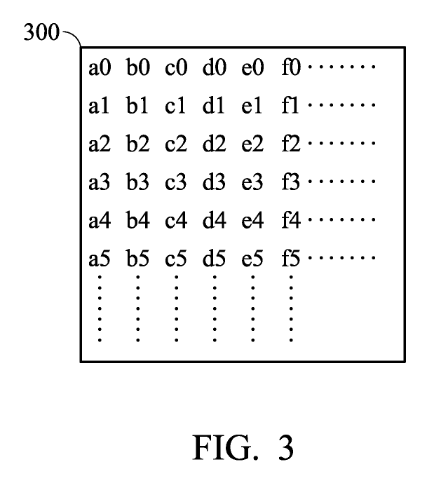

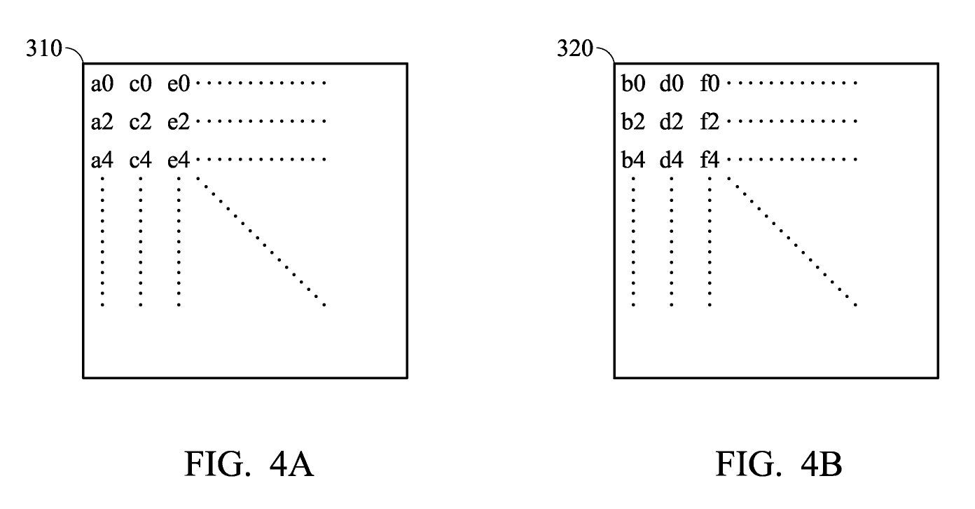

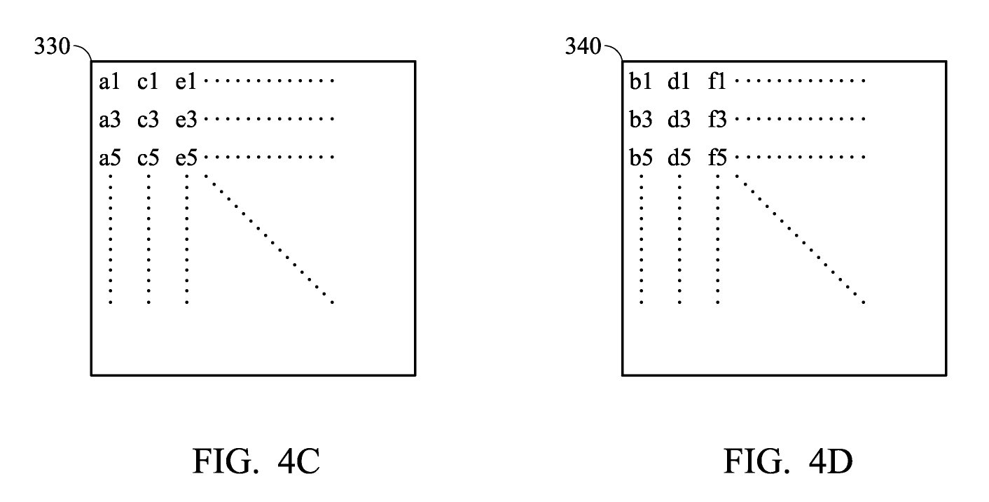

In step S202, an image is captured via the image capture unit of the electronic device. Then, in step S204, a plurality of smaller images is created according to the captured image, wherein the resolutions of the respective smaller images are the same. It is understood that, the respective smaller images can be created based on the captured image using a pixel shift technique. That is, the pixels contained in the respective smaller images are not overlapped, and shifts may exist among the pixels. For example, FIG. 3 shows an example of an image 300. FIGS. 4A˜4D shows smaller images 310˜340 created based on the image 300 using a pixel shift technique. It is noted that, the smaller images 310˜340 are examples of the present invention. The number of the smaller images and the distribution of pixels of the respective smaller images in the original image can be adjusted according to various applications. Then, in step S206, the image and the smaller images are stored as an image file having a specific image format. It is understood that, in some embodiments, the specific image format may be an image format of JPEG, and the size of the respective smaller images may be 160×120. It is noted that, the JPEG image format defines an image with an original size, and an image thumbnail with a predefined resolution. In the present application, each of the smaller images created based on the image may have the predefined resolution of the image thumbnail defined in the JPEG image format.

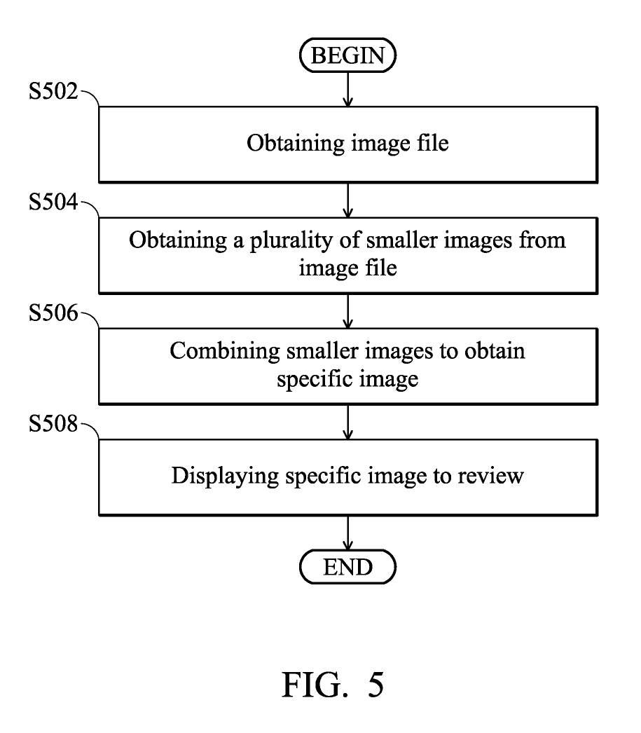

FIG. 5 is a flowchart of an embodiment of a method for image capture and processing of the invention. The method for image capture and processing can be used in an electronic device, such as a digital camera, or a handheld device, such as a PDA, a smart phone, and a mobile phone.

In step S502, an image is obtained from the storage unit of the electronic device, wherein the image file comprises an image and a plurality of smaller images corresponding to the image. In step S504, all of the smaller images are obtained from the image file, and in step S506, the smaller images are combined to obtain a specific image. For example, the smaller images 310˜340 in FIGS. 4A˜4D are read from the image file, and the smaller images 310˜340 are combined as the specific image. It is understood that, in steps S504 and S506, all smaller images are read and combined. However, in some embodiments, the number of smaller images used to generate the specific image can be determined according to the resolution of the display unit. First, the resolution of the display unit of the electronic device is obtained, and a specific number is determined according to the resolution of the display unit and the resolution of the smaller image. Then, the specific number of smaller images are obtained from the image file, and combined as the specific image. For example, if the resolution of the display unit is 640×480, and the resolution of the smaller image is 160×120, 4 smaller images can be read from an image file, and combined to generate a specific image. In this case, the resolution of the specific image equals to the resolution of the display unit. After the specific image, in step S508, the specific image is displayed in the display unit of the electronic device for browsing.

Therefore, the methods and systems for image capture and processing can create a plurality of smaller images during image capture, and speed up image browsing using the smaller images.

Methods and systems for image capture and processing, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for image capture and processing for use in an electronic device comprising an image capture unit, comprising:
capturing an image via the image capture unit;
creating a plurality of smaller images according to the image, wherein the resolutions of the respective smaller images are the same; and
storing the image and the smaller images as an image file.

2. The method of claim 1, further comprising:
obtaining the smaller images from the image file;
combining the smaller images to obtain a specific image; and
displaying the specific image in a display unit of the electronic device.

3. The method of claim 2, further comprising:
obtaining the resolution of the display unit;
determining a specific number according to the resolution of the display unit and the resolution of the respective smaller images; and
obtaining the specific number of the smaller images from the smaller images in the image file to generate the specific image.

4. The method of claim 2, wherein the resolution of the specific image equals to the resolution of the display unit.

5. The method of claim 1, wherein the smaller images are created based on the image using a pixel shift technique.

6. The method of claim 1, wherein the image file conforms to an image format of JPEG, and the size of the respective smaller images is 160×120.

7. A method for image capture and processing for use in an electronic device comprising a display unit, comprising:
obtaining a plurality of smaller images from an image file, wherein the resolutions of the respective smaller images are the same;
combining the smaller images to obtain a specific image; and
displaying the specific image in the display unit of the electronic device.

8. The method of claim 7, further comprising:
obtaining the resolution of the display unit;
determining a specific number according to the resolution of the display unit and the resolution of the respective smaller images; and
obtaining the specific number of smaller images from the smaller images in the image file, thus to generate the specific image.

9. The method of claim 7, wherein the resolution of the specific image equals to the resolution of the display unit.

10. The method of claim 7, wherein the image file conforms to an image format of JPEG, and the size of the respective smaller images is 160×120.

11. A system for image capture and processing for use in an electronic device, comprising:
an image capture unit capturing an image; and
a processing unit creating a plurality of smaller images according to the image, and storing the image and the smaller images as an image file, wherein the resolutions of the respective smaller images are the same.

12. The system of claim 11, further comprising a display unit, wherein the processing unit further obtains the smaller images from the image file, combines the smaller images to obtain a specific image, and displays the specific image in the display unit.

13. The system of claim 12, wherein the processing unit further obtains the resolution of the display unit, determines a specific number according to the resolution of the display unit and the resolution of the respective smaller images, and obtains the specific number of smaller images from the smaller images in the image file, thus to generate the specific image.

14. The system of claim 12, wherein the resolution of the specific image equals to the resolution of the display unit.

15. The system of claim 11, wherein the smaller images are created based on the image using a pixel shift technique.

16. The system of claim 11, wherein the image file conforms to an image format of JPEG, and the size of the respective smaller images is 160×120.

17. A system for image capture and processing for use in an electronic device, comprising:
a storage unit comprising an image file;
a display unit; and
a processing unit obtaining a plurality of smaller images from an image file, combining the smaller images to obtain a specific image, and displaying the specific image in the display unit of the electronic device, wherein the resolutions of the respective smaller images are the same.

18. The system of claim 17, wherein the processing unit further obtains the resolution of the display unit, determines a specific number according to the resolution of the display unit and the resolution of the respective smaller images, and obtains the specific number of smaller images from the smaller images in the image file, thus to generate the specific image.

19. The system of claim 17, wherein the resolution of the specific image equals to the resolution of the display unit.

20. The system of claim 17, wherein the image file conforms to an image format of JPEG, and the size of the respective smaller images is 160×120.
